(19) United States
(12) Patent Application Publication
(10) Pub. No.: US 2021/0172719 A1
(43) Pub. Date: Jun. 10, 2021

(54) Method for Determining Dimensional Properties Of a Measurement Object Using a Coordinate Measuring Machine

(71) Applicant: Carl Zeiss Industrielle Messtechnik GmbH, Oberkochen (DE)

(72) Inventor: Jonas Michael FRANK, Stimpfach (DE)

(21) Appl. No.: 17/118,354

(22) Filed: Dec. 10, 2020

(30) Foreign Application Priority Data
Dec. 10, 2019 (EP) 19 214 915.1

(51) Int. Cl. G01B 5/008

(52) U.S. Cl. CPC G01B 5/008

(57) ABSTRACT

A method includes receiving a command designating a desired measurement path, including desired start and end positions. The method includes searching a data memory to find a first measurement path corresponding to the command. The first measurement path includes first start and end positions. The method includes, in response to the search being successful (the first measurement path corresponds to the command), reading the first measurement path and controlling a measuring head of a coordinate measuring machine to move along the first measurement path to capture a measurement point on the measurement object. The method includes, in response to the search being unsuccessful, calculating a second measurement path, storing the second measurement path in the data memory, and moving the measuring head along the second measurement path to capture the measurement point. The method includes determining dimensional properties of the measurement object based on the measurement point.

### CROSS-REFERENCE TO RELATED APPLICATIONS

This application claims priority to European Patent Application No. 19 214 915.1 filed Dec. 10, 2019. The entire disclosure of the application referenced above is incorporated by reference.

### FIELD

The present invention relates to industrial measurement technology and more particularly to determining dimensional properties of a measurement object using a coordinate measuring machine.

### BACKGROUND

In principle, it is possible to manually control the movements of the measuring head relative to the measurement object. However, an automated measuring procedure is desirable in the quality control of industrially produced products, such that, for example, a plurality of measurement objects can be measured as quickly and reproducibly as possible. In the case of such a measuring procedure, a measuring head of the coordinate measuring machine is usually moved along a predefined measurement path, which was planned in advance by a software application on the basis of the object to be measured. The creation of such an automated measuring procedure requires knowledge about the functionality of coordinate measuring machines and experience as to how different measurement objects can be measured best.

In the case of flexible measurement surroundings or in the case of constantly changing measurement conditions, measurement path planning in the current state-of-the-art is often carried out in real time, immediately before the respective movement of the measuring head.

By way of example, under the designation CALYPSO, Carl Zeiss Industrielle Messtechnik GmbH offers software for creating such real time measurement paths or real time measurement sequences and for processing the measurement results obtained. The basic principles of CALYPSO are described for example in a brochure entitled “Einfach Messen und was Sie dazu wissen sollten—Eine Fibel der Messtechnik” [“Straightforward measurement and what you should know to implement it—Primer for metrology”] (order number from Carl Zeiss: 61212-2400101) or in an advertisement brochure from Carl Zeiss Industrielle Messtechnik GmbH entitled “Calypso. Einfach programmieren” [“Calypso. Simple programming”] (publication number 60-11-068).

The measurement sequence is created by CALYPSO on the basis of so-called test features. A test feature represents an actual dimensional property of one or more geometric elements (so-called measurement elements) on a measurement object, such as, for instance, the diameter of a bore, the roundness of a cylinder section or the relative distance between two geometric elements. As a rule, a plurality of measurement points on a measurement object have to be captured and approached by the measuring head in order to quantify a test feature.

For the purposes of creating the measurement sequence, the user frequently sets the desired test features on the basis of CAD data and, in this context, selects various parameters, including parameters for the subsequent machine movements. CALYPSO offers respectively preset parameters to this end, which parameters have proven their worth for a great number of measurement problems. In principle, measurement elements and test features can also be created without CAD data (for example, by virtue of the intended data being entered by a user). Moreover, the parameters can be altered by an experienced user in order to adapt the measuring procedure to certain measurement conditions (e.g., a displacement speed or tolerance). By means of the orientation to test features, CALYPSO makes it easier for the user to create the measuring procedure because the test features generally correspond to specifications which the operator can gather from a technical drawing of the measurement object.

With the selection of the test features, CALYPSO creates control commands, for example for a CNC controller, by means of which the measuring head is controlled in such a way that a desired measurement point can be approached from a start position at which the measuring head is situated at this time. The position at which the measurement point is measured corresponds to a end position, to which the measuring head should be displaced starting from the start position. By way of example, the measuring head can be displaced from a first measurement point on a measurement object to a second measurement point on the same measurement object, or between two different measurement objects.

Path planning in the CNC operation can be implemented by calculating a respective measurement path between the respective start positions and end positions by means of an algorithm, wherein the shortest or fastest path between the start position and end position can be calculated and selected, preferably immediately before each movement of the measuring head. A plurality of information items about the measurement surroundings or the measurement setup and possibly present or newly added interference contours can be included during this real-time calculation in order to ensure a collision-free measuring procedure.

The algorithms used for real-time path planning, for example a so-called rapidly exploring random tree algorithm, can operate on the basis of random numbers. As a result, a renewed calculation of a measurement path between the start position and end position can lead to a deviating measurement path, even in the case of an unchanged start position and end position, the deviating measurement path deviating from a previously calculated measurement path, i.e., being shorter or longer, for example.

In turn, this sometimes leads to deviating measurement paths and deviating measurement times when one and the same measurement process is repeated, even though the start position and end position are identical. Despite in fact identical measurement paths, the start position and end position are not, however, always exactly the same since each coordinate measuring machine has a limited measurement and approach accuracy. In addition to the measurement and approach accuracy of the coordinate measuring machine or the accuracy of the translational and rotational movement axes of the coordinate measuring machine, the measurement object to be measured (e.g., component) can also influence the start position and end position.

By way of example, if the same test plan is carried out multiple times with different measurement objects, an alignment of the measurement object, for example, can also have an influence on an alignment of a base system (the component-related coordinate system in the machine coordinate system). This is because an assumption can be made that the measurement object cannot be positioned in exactly the same way, which is why the base system is recalibrated as a rule, i.e., a transformation from the base system to the machine coordinate system is calculated anew. The test plan itself (e.g., the measurement elements) is normally related to the base system. The movement of the machine is implemented, in end effect, in the machine coordinate system. The approach position and the “depart position” (in general: transfer position) to and from a measurement element in the machine coordinate system and/or the alignment of the measurement element (e.g., a straight line) and, following therefrom, the angular position of the machine at the transfer position, for example, can consequently differ slightly.

This appears problematic in respect of the temporal certainty and the achievable accuracy, particularly in the case of highly clocked measuring procedures, for example for quality assurance of components in industrial surroundings. Consequently, this real-time path planning is a time-critical procedure on account of the random number-based calculation of measurement path and can only be optimized slightly since there is no computational time available for a more in-depth measurement path optimization.

A further problem with the real-time measurement path planning is that users of measuring machines out of habit expect unchanging movement processes and unchanging measurement times for the measurement of the same measurement objects. By way of example, within the scope of industrial production, equipping times needed to equip the measuring machine with a new measurement object are planned and optimized in advance, including the measurement time, so that a certain number of pieces can be obtained per hour or per shift. Consequently, this also requires a measurement time that is as uniform as possible.

The real-time path calculation is confronted with the procedure when planning the path in typical fields of work of industrial robots. By way of example, these industrial robots are used in fully or partly automated production lines. Here, as a rule, each industrial robot is tasked with a predetermined work step (e.g., punching holes) and has an unchanging sequence of movements or a sequence of movements with restricted variation in each work step. This constancy allows the work paths of the industrial robot to be calculated in advance, decoupled in terms of time, by means of path planning software and, for example, be stored in machine-readable fashion in a robot controller. As a result, this type of path planning is not a time-critical procedure. The measurement path can be optimized in advance, even with a great time outlay, with even work tolerances of the industrial robot being able to be eliminated by calculation without representing a time-critical variable. A further example of a calculation of the work paths in advance represents the generation of so-called scanning trajectories, which are likewise generated in advance and stored in a measurement element of the test plan.

Despite the aforementioned problem, it is advantageous in a plurality of measuring procedures in various fields of application to flexibly design the associated test plans. However, path planning as carried out in the case of industrial robots only has limited suitability in this case, and so real-time path planning has been used up until now. By way of example, the number and/or sequence of measurement points, approached during the CNC operation, might change in some test plans and when measuring measurement objects. On account of this, such cases have until now required the measurement path planning to still be implemented in real time. For reasons of performance and time, it was previously not advantageous to plan measurement paths in advance, like in the case of industrial robots. Moreover, a sequence of the measurement elements within a CNC control sequence might not be known from the start and, for example, might only emerge during the measuring procedure. Consequently, a calculation of the measurement paths in advance is not possible in such cases.

### SUMMARY

In view of the above, it is an object of the present invention to provide a method and an apparatus for determining dimensional properties of a measurement object more efficiently.

According to a first aspect there is provided a method for determining dimensional properties of a measurement object using a coordinate measuring machine, the coordinate measuring machine comprising a measuring head configured for capturing at least one a measurement point on the measurement object, comprising drives configured for moving the measuring head relative to the measurement object, comprising an evaluation and control unit for controlling the drives, and comprising a data memory in which a database is provided, with the database storing a plurality of predefined measurement paths each having a predefined respective start position and a predefined respective end position, wherein the method includes the following steps of receiving an input command comprising a predetermined information item representing a desired measurement path from a first start position to a first end position, of searching the database in order to find a first predefined measurement path corresponding to the predetermined information item, with the first predefined measurement path comprising a second start position and a second end position, and if the search is successful and the first predefined measurement path corresponds to the predetermined information item, of reading the first predefined measurement path from the database and moving the measuring head along the first predefined measurement path from the second start position to the second end position and capturing the at least one measurement point, and if the search is not successful such that no predefined measurement path corresponding to the predetermined information item is found, calculating a second measurement path with a third start position and a third end position in response to the input command, storing the second measurement path in the database, and moving the measuring head along the second measurement path from the third start position to the third end position and capturing the at least one measurement point, and determining the dimensional properties of the measurement object on the basis of the captured at least one measurement point.

According to another aspect, there is provided an apparatus for determining dimensional properties of a measurement object, comprising a workpiece receptacle for holding the measurement object, comprising a measuring head for capturing at least one measurement point on the measurement object, the measuring head being displaceable relative to the workpiece receptacle, comprising drives for displacing the measuring head along a plurality of movement axes, comprising an evaluation and control unit for controlling the drives and for receiving a measurement signal which the measuring head generates when capturing the at least one measuring point, and comprising a data memory in which a database is provided, with the database storing a plurality of predefined measurement paths each having a predefined respective start position and a predefined respective end position, wherein the evaluation and control unit is configured for
receiving an input command comprising a predetermined information item representing a desired measurement path from a first start position to a first end position,
searching the database in order to find a first predefined measurement path corresponding to the predetermined information item, with the first predefined measurement path comprising a second start position and a second end position, and
if the search is successful and the first predefined measurement path corresponds to the predetermined information item, reading the first predefined measurement path from the database and moving the measuring head along the first predefined measurement path from the second start position to the second end position and capturing the at least one measurement point,
if the search is not successful such that no predefined measurement path corresponding to the predetermined information item is found, calculating a second measurement path with a third start position and a third end position in response to the input command, storing the second measurement path in the database, and moving the measuring head along the second measurement path from the third start position to the third end position and capturing the at least one measurement point, and
determining the dimensional properties of the measurement object on the basis of the captured at least one measurement point.

There is also provided a computer program product comprising a tangible storage medium with program code, the program code being configured to execute a method for determining dimensional properties of a measurement object using a coordinate measuring machine, the coordinate measuring machine comprising a measuring head configured for capturing at least one a measurement point on the measurement object, comprising drives configured for moving the measuring head relative to the measurement object, comprising an evaluation and control unit for controlling the drives, and comprising a data memory in which a database is provided, with the database storing a plurality of predefined measurement paths each having a predefined respective start position and a predefined respective end position, wherein the method includes the following steps: receiving an input command comprising a predetermined information item representing a desired measurement path from a first start position to a first end position; searching the database in order to find a first predefined measurement path corresponding to the predetermined information item, with the first predefined measurement path comprising a second start position and a second end position; and, if the search is successful and the first predefined measurement path corresponds to the predetermined information item, reading the first predefined measurement path from the database and moving the measuring head along the first predefined measurement path from the second start position to the second end position and capturing the at least one measurement point; if the search is not successful such that no predefined measurement path corresponding to the predetermined information item is found, calculating a second measurement path with a third start position and a third end position in response to the input command, storing the second measurement path in the database, and moving the measuring head along the second measurement path from the third start position to the third end position and capturing the at least one measurement point, and determining the dimensional properties of the measurement object on the basis of the captured at least one measurement point

An advantage of the novel method or the novel apparatus consists of the fact that, inter alia, it links the advantages of the two previously alternative methods for path planning (path calculation in real-time and path calculation in advance) and, as it were, represents a developed hybrid of both approaches.

The particularly advantageous modification in relation to the prior art lies in the use of the data memory. The data memory is preferably a buffer, which is known as a “cache” in information technology. Thus, the data memory is preferably a buffer, which allows minimization of complicated recalculations. By way of example, the data memory can be embodied in the form of a RAM memory, with, as a matter of principle, an implementation of the data memory on an SSD hard disk drive or a (cloud) server also being conceivable. The buffer or cache can preferably be stored in the test plan as a file. As soon as the test plan is loaded, the buffer with database is also loaded into the RAM.

The database is stored in the data memory, wherein presently the term “database” should not necessarily be understood to mean a database such as, e.g., an SQL database. Rather, storing individual files, data bundles or else data in any other tabular, textual or binary form can also be understood to mean a database.

Preferably, the data memory is not arranged directly in the coordinate measuring machine or in the evaluation and control unit but preferably merely has an indirect connection to one or more components of the coordinate measuring machine.

Preferably, the data memory is independent of a kinematic chain formed by a plurality of movement axes of the coordinate measuring machine. The data memory according to the invention can be used both in coordinate measuring machines (e.g., also with 6-axis scanning) and in industrial robots. Since the data memory preferably operates in the background, the CALYPSO measurement path planning software is assisted and accelerated. This leads to shorter calculation times and greater comfort for a user. By way of example, cost calculations when sorting measurement elements in a test plan can be accelerated by the use of the data memory.

Further, the data memory can receive direct or indirect information (e.g., current measurement elements, sequence of the measurement elements, etc.) from a measurement test plan created in advance, for example using the CALYPSO software; however, this is not decisive for the functionality. Preferably, the data memory can be considered to be a “plug-in” of the measurement path generation, which, as it were, always assists “in the background”. Preferably, the data memory can also serve as a buffer for a plurality of coordinate measuring machines. It preferably makes no difference to the measurement software whether or not the cache is present (apart from the calculation time) since the same interfaces are always addressed.

As a result of the data memory, in which the database with a plurality of predefined measurement paths is stored, the storage of the measurement paths can be carried out dynamically, as it were in a manner similar to real-time operation. This leads to calculation time being saved during CNC control operation, in which the measuring head is displaced from a desired start position to a desired end position. This can reduce the time required to drive new measurement points.

Preferably, the plurality of predefined measurement paths can additionally be stored on a backup data memory. Moreover, it is preferable if the plurality of predefined measurement paths can also be loaded into the data memory from a different storage medium, wherein the data memory preferably facilitates storing of the plurality of predefined measurement paths in any desired data format. Preferably, further properties of the measurement paths (e.g., information about the measurement elements) can also be stored in addition to the respective start position and end position. Likewise, storage of variables specific to the data memory, such as its capacity and rounding tolerance, is possible.

The plurality of predefined measurement paths preferably result from coordinate measurements carried out in advance, which were carried out using the coordinate measuring machine. In the previously carried out measurements, at least the respective start position and end position of the measurement head were preferably respectively stored in the data memory or the database as a measurement path. These predefined measurement paths are available in stored, retrievable form and serve, as it were, as a database for (CNC) control of the measuring head to be carried out in the future.

The data memory serves to buffer measurement paths or travels. It is preferably irrelevant in this case how the plurality of predefined measurement paths were generated. By way of example, the plurality of predefined measurement paths can be implemented by a (manual) user input, a semi-automatic, software-based measurement path generation or by measurement path planning. By way of example, the plurality of measurement paths can also be buffered in advance and need not necessarily be implemented during live operation of the coordinate measuring machine, i.e., for example, during the CNC procedure.

By way of example, if an input command defines a new first start position and new first end position, each of which are part of a measurement path yet to be calculated, the database can preferably be searched for a (first) measurement path of a preceding measurement, which has a second start position and second end position which correspond to the first start position and first end position within the predefined tolerance and/or in which a comparison information item (e.g., a name of a test element in a test plan) corresponds to a predefined information item from the test plan (e.g., to a name of an already defined test element in the test plan).

In principle, the predefined information item can be a verifiable information item from the test plan, which is comparable. By way of example, the name (e.g., “straight line 1”) of a first predetermined measurement element, against which the first predefined measurement path was placed, can be compared to the name of a newly placed measurement element, on which the first start position and first end position were defined. By way of example, the first measurement path is read from the database if the names correspond. Expressed differently, searching for the first measurement path can also be carried out by way of properties or a predefined information item, even from the test plan or the description of the measurement path to be carried out, without a tolerance criterion being required.

The tolerance preferably corresponds to a manufacturing tolerance of the coordinate measuring machine. Expressed differently, this means that the predefined tolerance specifies the reproducible accuracy with which the coordinate measuring machine can approach one and the same measurement point on the measurement object. If the first start position and/or end position deviates from the second predefined start position and/or end position, for example by several tenths of a millimeter, and if the coordinate measuring machine has a measurement tolerance or approach accuracy of the same order, the first measurement path is loaded from the data memory even though the first start position and first end position do not exactly correspond to the second start position and second end position.

The input command can be a manual input or control command, which, for example, is entered into the control unit by a user. As an alternative or in addition thereto, this might relate to an automatically generated control command, for example by CALYPSO, by means of which at least a start position and end position for approaching a certain measurement point are generated, preferably on the basis of the measurement test plan created with CALYPSO.

If a corresponding measurement path is found in the database, the evaluation and control unit reads this (first) measurement path from the database and controls the measuring head on the basis of this measurement path. This is advantageous in that a new measurement path need not always be calculated between the entered start position and end position but that use can be made of an already stored, predefined measurement path should the latter lie within the predefined tolerance and/or should the comparison information item correspond to the predetermined information item. This reduces the calculation time.

By contrast, if it proves impossible to find a second start position and second end position which correspond within the predefined tolerance to the entered first start position and first end position and/or for which the comparison information item corresponds to the predetermined information item, a new second measurement path is preferably calculated by a known algorithm for path planning, the new second measurement path being transmitted to the control unit and being used to control the measuring head. In this case, the second measurement path is stored in the data memory in order to increase the number of predefined measurement paths for subsequent measurements. With an increasing number of stored, predefined measurement paths, the probability of finding a measurement path when searching the database increases, the start position and end position of the measuring path corresponding to the entered first start position and first end position within the predefined tolerance and/or for which the comparison information item corresponds with the predefined information item such that, if not desired, there is no need for a recalculation.

Moving the measuring head between the start position and end position is implemented by driving drives for the movement axes of the coordinate measuring machine and changing at least one degree of freedom for at least one of the movement axes.

In one embodiment, the method if the first and the second start position and/or the first and the second end position do not correspond within the predefined tolerance and/or if the comparison information item does not correspond with the predetermined information item further includes the steps of: Searching the database for a third predefined measurement path with a fourth start position and a fourth end position, in which the first start position and the fourth end position and the first end position and the fourth start position correspond to one another within the predefined tolerance and, if the third predefined measurement path is found: reading the third measurement path from the database, inverting the fourth start position and the fourth end position, and moving the measuring head along the third measurement path from the inverted fourth end position to the inverted fourth start position, at which the measurement point is captured.

This embodiment is advantageous in that, before a recalculation of the second measurement path, for which computation time needs to be made available, is initiated, a check is carried out in advance whether a predefined measurement path has already been stored in the data memory, the associated start position and end position of which spatially correspond with the entered first start position and first end position, with, however, the start and end of the associated measurement path being interchanged. If the first measurement path is not found in the data memory, an inverted measurement path is initially search from the data memory. In terms of magnitude, the inverted measurement path corresponds to the first measurement path, although a movement direction of the measuring head needs to be inverted in order to travel between the desired fourth start position and fourth end position. If an inverted measurement path is present in the data memory, the first start position corresponds to the fourth end position and the first end position corresponds to the fourth start position. Inverting the fourth start position and fourth end position can preferably be implemented by redefining or marking the respective position coordinates as end position and start position, respectively, or by inverting a displacement direction of the measuring head preferably belonging to the third predefined measurement path.

This embodiment addresses the so-called “symmetric problem”. A symmetric problem can be formulated mathematically as follows: Result_{a,b}=−Result_{b,a}. If, in the case of such a symmetric problem, the evaluation and control unit cannot find the first measurement path with a first displacement direction preferably belonging thereto, a search is carried out for an inverted first measurement path. If the latter is found, it is retrieved and inverted in terms of its direction. As a result, the (re-)calculation of the second measurement path can preferably be prevented, leading to savings in terms of computation time and storage space.

In a further embodiment, the method further includes the step of adapting the respective start position and/or end position of the respectively read measurement path for the purposes of compensating the predefined tolerance.

This embodiment is advantageous in that deviations between the first start position and the second start position and/or the first end position and the second end position can be compensated. The deviations arise, for example, due to manufacturing inaccuracies when manufacturing the coordinate measuring machine (e.g., relating to the drives or the movement axes), and lead to the coordinate measuring machine in subsequent operation only being able to approach a certain position in space with a tolerance-affected accuracy. Further, the deviations may also arise from deviations when positioning the component, as already described above. Expressed differently, the start position and/or end position of the measurement path read from the data memory is modified in a suitable fashion, for example, by including the predefined tolerance, such that it corresponds to the entered first start position and/or end position. As a result, it is possible to increase the accuracy when approaching the desired measurement point and consequently improve the measurement accuracy.

In a further embodiment, the method further includes the steps of: comparing the respectively adapted start position to the first start position and the respectively adapted end position to the first end position, and if the first start position and the respectively adapted start position and the first end position and the respectively adapted end position correspond within a predefined second tolerance: moving the measuring head along the adapted measurement path from the adapted start position to the adapted end position, at which the measurement point is captured, and if the first and the respectively adapted start position and/or the first and the respectively adapted end position do not correspond within the predefined second tolerance: calculating the second measurement path, storing the second measurement path in the database, and moving the measuring head along the second measurement path from the third start position to the third end position, at which the measurement point is captured.

This embodiment serves as an additional safety level, by means of which a correct, error-free approach of the desired end position is intended to be ensured. Here, the adapted start position and/or end position substantially emerging from the adaptation are compared to the entered first start position and end position. Consequently, this prevents errors during the adaptation from transferring to a subsequent measurement point recording and possibly from being amplified by a chain of errors.

As it were, the embodiment describes a first advantageous mode of the novel method. If the adapted measurement path is not valid or if no measurement path was found in the data memory, a new measurement path is calculated and stored in the data memory, whereas there is no recalculation of the measurement path if the adapted measurement path is valid. The predefined second tolerance is preferably smaller than the predefined tolerance, which should be compensated for by the adaptation. The second tolerance preferably serves to check again whether an error has arisen during the adaptation. By way of example, the second tolerance is an epsilon criterion (limit criterion when rounding floating-point numbers).

It is ensured that the desired end position can also be reached by the adapted measurement path or whether the calculation of the second measurement path is required for reaching the first end position in error-free fashion. This is preferably carried out within the scope of collision testing. The verification step only requires little calculation time and computational power but accelerates the measurement method to the effect of being able to minimize measurement errors such that, for example, repeated recording of a measurement value on account of a preceding fault measurement can be reduced. Further, an advantageous collision check can ensure that there is no collision with, e.g., an interference contour during the displacement of the measuring head, as a result of which, for example, parts of the coordinate measuring machine could be damaged. Preferably, a check can be carried out as to whether the adapted measurement path between the adapted start position and end position is possibly longer than the measurement path read from the data memory and, should the adapted measurement path be longer than the measurement path read from the buffer, there can preferably be recalculation of the second measurement path. This leads to a shorter displacement time.

The comparison or the validation is preferably moreover implemented with the aid of collision testing. A validation is carried out here that there is no collision object which could collide with the measuring head during the displacement situated in the adapted measurement path, i.e., between the adapted start position and end position. A collision check need not be included if, for example, no “new” interference contours have been added to the testing plan and if there have been no other changes in the coordinate measuring machine. If the comparison fails on account of a detected risk of collision, it is possible, for example, to calculate a new, collision-free path. Alternatively, the CNC procedure can also be terminated, with a notification for the user preferably being output in such a case. As an alternative or in addition thereto, other comparison mechanisms, e.g., a pure plausibility check (adapted measurement path must not lie outside a certain region) would also be conceivable.

In a further embodiment, the method if the first and the second start position and the first and the second end position correspond within the predefined tolerance and/or if the comparison information item corresponds with the predetermined information item further includes the steps of: calculating the second measurement path, comparing the first and the second measurement path taking the predefined tolerance into account, and if the third start position has a smaller deviation from the first start position than the second start position has from the first start position and/or if the third end position has a smaller deviation from the first end position than the second end position has from the first end position: storing the second measurement path in the database and moving the measuring head along the second measurement path from the third start position to the third end position, at which the measurement point is captured.

The second measurement path is always calculated in this embodiment, i.e., independently of whether a measurement path corresponding to the first start position and first end position is found in the data memory. As it were, this embodiment forms a second mode of the novel method. This is advantageous in that there can be a direct comparison between the predefined first measurement path and the newly calculated second measurement path, and so it is possible to select the shorter or faster one of the two measurement paths and store the latter in the data memory for future measurements. Consequently, new measurement path planning is started every time and, should a first measurement path have been found in the data memory and been adapted and validated where necessary, the latter is compared to the newly calculated second measurement path. If the recalculated measurement path is shorter, it is used and written into the data memory. By contrast, if no appropriate first measurement path was found in the data memory, the end position is approached on the basis of the newly calculated second measurement path.

An advantage of this embodiment is that the CNC procedure overall can be optimized by a continuous recalculation and comparison of the measurement paths such that ever more optimal (shorter) paths can be used with an increasing number of predefined measurement paths. In contrast to the aforementioned first mode, less computation time is saved in the second mode; however, this can be compensated by virtue of shorter measuring paths being found by the recalculation and the comparison. As a result, the CNC control procedure overall can be faster in comparison with the first mode. Even though the achievable determinism in the second mode occurs more slowly in comparison with the first mode, a variance of the measurement paths among themselves reduces with an increasing number of predefined measurement paths stored in the data memory.

In a further embodiment, the method if the first and the second start position and the first and the second end position correspond within the predefined tolerance and/or if the comparison information item corresponds with the predetermined information item further includes the steps of: optimizing the read first measurement path on the basis of an optimization algorithm in order to determine a first optimized measurement path and moving the measuring head along the first optimized measurement path from the second start position to the second end position, at which the measurement point is captured.

In this configuration, the measurement path read from the data memory is preferably optimized by the application of an optimization algorithm, which leads to the advantage of the usability of an optimized measurement path. As it were, this embodiment represents a third mode, which arises from a mixture of the first and the second mode. Preferably, the path planning in the third mode can be subdivided to two areas. Usually, a path planning algorithm consists of a sub-algorithm (e.g., rapidly exploring random tree algorithm), which links the start position with the end position. As a result of the calculation, this calculated measurement path is collision-free but need not have an optimal length since the algorithm employed is based on random numbers and therefore not designed to calculate the optimal measurement path but only to calculate a possible measurement path between a start position and end position. As an alternative or in addition thereto, instead of a pure optimization of the measurement path length during the measurement path optimization, individual degrees of freedom of the movement axes of the coordinate measuring machine can also be weighted differently since, for example, a movement about an axis of rotation is implemented more slowly than a movement along a translational axis. Further, length comparisons (e.g., between two measurement paths) are possible. Further, use can also be made of weighting criteria for the purposes of optimizing measurement paths.

Following the path planning algorithm, an optimization algorithm is additionally implemented and applied to the measurement path which has been read from the data memory and possibly already adapted, in order to obtain a measurement path that is as optimal (e.g., as short) as possible. An example optimization algorithm can be gathered from http://www.factory-in-a-day.eu/wp-content/uploads/2017/08/paper_Advanced-Robotics_2016.pdf. Preferably, attempts are made in the process of, for example, removing and directly connecting or displacing intermediate steps in a measurement path. Following the elimination of such intermediate steps, there preferably are, once again, one or more collision checks in order to validate the optimized measurement path. In comparison with the first mode, the third mode is carried out more slowly but it is faster than the second mode on account of not always carrying out a recalculation of a measurement path. In the case of a deterministic optimization algorithm, the measurement paths optimized thereby are also deterministic, similar to the first mode.

In a further embodiment, the data memory has a predefined storage capacity, which is determined by a predefined number of storable, predefined measurement paths.

Here, the term “predefined storage capacity” is understood to mean that the size of the data memory (measured in megabytes (MB) or gigabytes (GB)) is preferably determined either by a maximum storage capacity of the memory per se or by predefined partitioning of an actually larger storage medium. By way of example, in the case of a random access memory (RAM) of a computer with a maximum storage capacity of 8 GB, it is possible to provide a storage partition for the data memory of 4 GB. The storage capacity is preferably set by the number of predefined measurement paths that are intended to be stored in the data memory. Moreover, the storage capacity can also orient itself on a number of measurement elements to be measured in a test plan.

In a further embodiment the method if the predefined number of storable, predefined measurement paths has been reached includes at least one of the following steps: deleting at least one stored, predefined measurement path if the latter has not been taken into account within a predefined number of searches of the database or determining a shortest measurement path of the stored, predefined measurement paths and deleting the shortest measurement path.

According to this embodiment, memory capacity of the data memory can be cleared on the basis of predefined regulations or guidelines for deleting predefined measurement paths should the data memory be full or if a plurality of stored, predefined measurement paths have not been read from the memory for relatively long period of time (in the last n measurements). Which one(s) of the plurality of stored measurement paths should be deleted from the data memory can be decided on the basis of predetermined criteria. As an alternative or in addition to the deletion, a storage of a recalculated measurement path can be prevented until a previously stored measurement path has been deleted.

The deletion of the individual measurement paths no longer required is preferably implemented on the basis of an identification of which of the measurement paths have not been read from the data memory during a predefined number of measurements and/or on the basis of an ascertainment of the shortest measurement path stored in the data memory. The shortest measurement path can be deleted on account of the fact that a recalculation of this measurement path requires the least calculation time. Moreover, a deletion on the basis of a weighting of the two deletion criteria is conceivable. As an alternative, it is also possible to reset to the entire data memory, i.e., delete all measurement paths stored. Moreover, a deletion of a plurality of measurement paths belonging to a certain measurement element is possible if the measurement element was removed from the test plan.

The deletion of the measurement path or measurement paths from the data memory can preferably also be implemented in reversible fashion. By way of example, it is possible to store a memory content of the data memory on a backup data medium prior to the deletion of individual measurement paths in order to have the option of loading the data content of the data memory from the backup data medium.

In a further embodiment, the plurality of predefined measurement paths includes at least one of the following information items: a displacement speed of the measuring head for one or more path sections between the respective start position and end position, a travel between the respective start position and end position, a tolerance value for the respective start positions and/or end positions, a collision object, which is arranged between the respective start position and end position, a rotary angle along a kinematic chain of the coordinate measuring machine, or a movement preference for a movement sequence of movement axes of the coordinate measuring machine.

These information items in respect of the plurality of measurement paths could have been entered into CALYPSO by a user when creating the test plan, for example. By way of these additional information items, the measurement path is comprehensively defined, as a result of which the evaluation and control unit can read all control information items for the optimal control of the measuring head directly from the data memory on account of the information items capturable about the measurement path.

The tolerance value can define a tolerance interval, within which a first start position or first end position and a second start position or second end position should be considered to be “corresponding”. This advantageously allows small deviations on account of manufacturing tolerances, wear, change in ambient conditions such as temperature to be taken into account. By way of example, the tolerance value for a start position or end position can be ±0.3 mm.

In the present case, the term “rotary angle along a kinematic chain of the coordinate measuring machine” should be understood to mean, for example, a relative position of the measuring head in relation to an axis of rotation, which should be taken into account when approaching an end position, for example. In some example embodiments, the measuring head can be fastened to the coordinate measuring machine by way of a rotary swivel joint and can accordingly be rotated in terms of its orientation. Further, the term “rotary angle along a kinematic chain of the coordinate measuring machine” can be understood to mean that information items about one or more rotary angles of an axis of rotation or the overall kinematic system (e.g., of the measuring head or a rotary stage) along the kinematic chain of the coordinate measuring machine may be available.

In the present case, the term “movement preference” should be understood to mean that, for example, movement axes to be driven by preference can be specified for some start positions and end positions and these facilitate a fast approach of this position. This is due to the fact that, inter alia, a rotational movement may be implemented in faster or slower fashion than a translational movement, for example. Moreover, the movement axis arranged closest to the measuring head along the kinematic chain can preferably be driven first.

In a further embodiment, a respective key value is determined on the basis of the respectively predefined start position and end position of the plurality of predefined measurement paths, each measurement path in the database being identified by the key value.

The key value preferably serves as an identifier, by means of which the associated measurement path can be uniquely read from the data memory. By way of example, a respective type of a respective movement axis and a respective start position and end position can be used as an example key value (start: t:10 t:0 t:0 r:90 r:0 r:180 I target: t:10 t:100 t:0 r:0 r:0 r:180). Alternatively, other encryptions which are suitable for assigning a predefined measurement path a uniquely identifiable key value are also possible.

In a further embodiment, the respective key value is further determined on the basis of the predefined tolerance.

In this embodiment, the key value can ensure a unique identifiability of a respective measurement path on account of the inclusion of the predefined tolerance, despite possible variations in the start positions and/or end positions. By very of example, these variations are caused by fluctuations of counters of the coordinate measuring machine. Thus, the key value is preferably rounded on the basis of the predefined tolerance. For an axis of rotation, the predefined tolerance is 0.3°, for example. For translational movement axes, the tolerance is 0.3 mm, for example.

The generation of the key value, with which the respective measurement path can be retrieved from the data memory, can preferably be embodied in such a way that the same key value is generated for different start values and/or different target values which, however, respectively lie within the predefined tolerance. This key tolerance can be different for each degree of freedom (or else for different machines/sensors). Preferably, the key value can include information items in relation to collision objects, which are stored, for example, in a test plan generated by CALYPSO. Alternatively, purely searching the database with a tolerance verification and/or use of additional information items from the test plan (e.g., the name of the start measurement element and end measurement element, etc.) is also conceivable. The key value can also be embodied in such a way that the same key value is generated in the case of a similar kinematic system of the coordinate measuring machine.

In a further embodiment, the database is formed as a hash table in which the plurality of predefined measurement paths are stored, wherein a respective index value is assigned to each of the predefined measurement paths, wherein, for each of the plurality of predefined measurement paths, an associated hash value is calculated on the basis of the respective key value by means of a hash function, wherein the respective hash value defines the respective index value, and wherein the respective measurement path is accessed via the respective hash value in the hash table.

According to this embodiment, the key value can preferably be converted into an associated hash value by the application of the hash function in order to be able to access the data memory or the database with a complexity of O(1), where O describes the so-called Landau symbol which, in complexity theory of information technology, is used to describe the complexity of computational processes. An access complexity O(1) states that the computational outlay remains constant, independently of the number of input variables.

As a result of the hash function, a mapping of an input set on a comparatively small target function is preferably obtained, and so this target function is not injective. Consequently, as it were, a hash function represents a mathematical one-way function. The hash values calculated by the hash function are preferably used in so-called hash tables. These hash tables facilitate an access complexity of preferably O(1).

In a further embodiment, the plurality of predefined measurement paths are calculated in advance and stored in the database of the data memory. Instead of a direct recalculation of the second measurement path if no adequate measurement path is found in the data memory, the user can preferably be displayed a notification in this embodiment that no measurement path has been found and that a recalculation would be necessary in order to displace the measuring head from the first start position to the first end position. Then, the user can preferably select whether a recalculation should be carried out.

In a further embodiment, the data memory can preferably be equipped with a “memory” such that different (storage) revisions of measurement paths are preferably encrypted with the same key value. If a measurement path of a revision is invalid, for example following a comparison with the first start position and first end position, older revisions are initially checked before there is a recalculation of the second measuring path. By contrast, once the maximum storage capacity of the data memory has been reached, it is advantageous if older revisions are deleted. The individual revisions need not necessarily be stored in a data memory but can be also stored, for example, in a revision memory (the “memory”). As an alternative or in addition thereto, all revisions of an individual measurement path can also be deleted together as a revision group if, for example, a certain revision group has not been used or only has had seldom use within a predetermined time interval.

It goes without saying that the aforementioned features and those yet to be explained below can be used not only in the combination specified in each case but also in other combinations or on their own, without departing from the scope of the present invention. Moreover, it is understood that the embodiments of the novel method relate in equivalent fashion to the novel apparatus without needing to be mentioned explicitly in conjunction with the novel apparatus.

### BRIEF DESCRIPTION OF THE DRAWINGS

Example embodiments are illustrated in the drawing and will be explained in greater detail in the following description.

FIG. 1 shows one example embodiment of the novel apparatus, which can be used to perform the novel method;

FIG. 2 shows a schematic illustration of an ideal and a real measurement path on a measurement object;

FIG. 3 shows a schematic illustration of a random number-based measurement path calculation;

FIG. 4 shows a flowchart of a first example embodiment of the novel method;

FIG. 5 shows a flowchart of a second example embodiment of the novel method;

FIG. 6 shows a schematic illustration of a measurement path adaptation;

FIG. 7 shows a schematic illustration of an inverted measurement path;

FIG. 8 shows a schematic illustration of a measurement path modification on account of a collision object; and

FIG. 9 shows a tabular representation of a measurement path calculation by means of the novel method.

### DETAILED DESCRIPTION

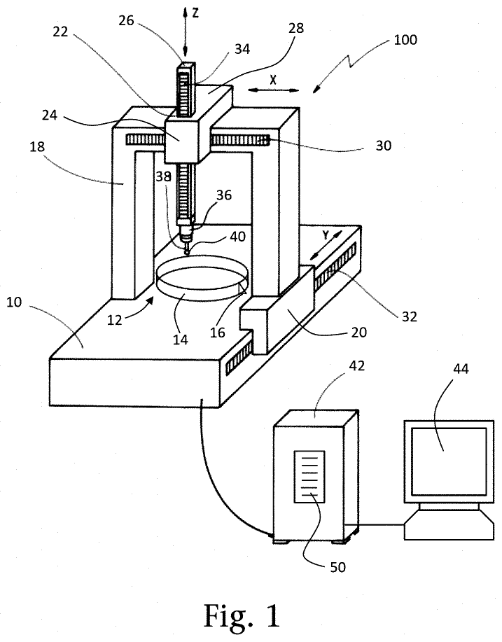

FIG. 1 shows a coordinate measuring machine or an apparatus on which the novel method for determining dimensional properties of a measurement object can be performed. The coordinate measuring machine is designated as a whole by the reference sign 100.

The coordinate measuring machine 100 comprises a base 10. The base 10 is preferably a stable plate, which is for example produced from granite. A workpiece receptacle 12 embodied to hold or receive a measurement object 14 is arranged on the base 10. To this end, one or more fastening elements 16 (e.g., clamps or screw clamps), for example, are provided on the workpiece receptacle, by means of which the measurement object 14 can be fastened, preferably in reversibly detachable fashion, to the workpiece receptacle 12. In the present case, the measurement object 14 is a ring gauge, as is used for calibrating coordinate measuring machines, for example.

A portal 18 is arranged on the base 10 such that it is displaceable in the longitudinal direction. The portal 18 serves as a movable support structure. The portal 18 has two columns projecting upward from the base 10, which are connected by a crossbeam and have an inverted U-shape overall.

The direction of movement of the portal 18 in relation to the base 10 is usually referred to as the Y-direction and is implemented by way of a first motor drive 20 (e.g., a stepper motor). In the present case, the first drive 20 is arranged in an end region, pointing to the base 10, of one of the downwardly directed columns and is configured to displace the portal 18 along the Y-direction. A carriage 22, which is displaceable in the transverse direction by way of a second motor drive 24, is arranged on the upper crossbeam of the portal 18. This transverse direction is usually referred to as the X-direction. In the present case, the second drive 24 is installed on the carriage 22. The carriage 22 carries a quill 26, which is movable in the Z-direction, i.e., perpendicularly to the base 10, by way of a third motor drive 28. The third drive 28 is integrated in the carriage 22. It should be mentioned that the drives 20, 24, 28 need not be arranged at the specified positions. By way of example, the third drive 28 can be installed in the quill 26.

Measurement devices on the basis of which the X-, Y- and Z-positions of the portal 18, the carriage 22 and the quill 26 can be determined are denoted by the reference signs 30, 32, 34. The measurement devices 30, 32, 34 are typically glass rulers, which serve as measuring scales. These measuring scales are formed in conjunction with corresponding reading heads (not shown here) to determine the respectively current position of the portal 18 in relation to the base 10, the position of the carriage 22 in relation to the upper crossbeam of the portal 18 and the position of the quill 26 in relation to the carriage 22.

A measuring head 36 is arranged at a lower, free end of the quill 26. The measuring head 36 is configured to capture measurement points on the measurement object 14. The measuring head 36 is part of a measurement sensor, the measurement sensor system of which can be arranged separately from the measuring head 36 or can be integrated in the latter and can be connected thereto by way of one or more cables or in wireless fashion. The measuring head 36 has a tactile stylus 38, which is directed downward in the Z-direction in the direction of the base 10. In other example embodiments, which are not shown, the measuring head 36 can also have a plurality of tactile and/or optical measurement heads, which can project in different spatial directions, for example. The stylus 38 is configured to probe a surface of the measurement object 14 by means of a probe head 40. By way of example, the probe head 40 is a ruby sphere.

It should be noted that by way of example a coordinate measuring machine 100 of a portal design is explained in FIG. 1. In principle, use can also be made of coordinate measuring machines 100 of a cantilever-arm, bridge or stand design. Depending on the type of construction of the coordinate measuring machine 100, the relative movement of the base 10 and the measuring head 36 along one, two or all three spatial directions can be implemented by a movability of the base 10 or the workpiece receptacle 12.

Alternatively, the coordinate measuring machine 100 can also be designed as an articulated arm system (for example of a robot) with a plurality of degrees of freedom. For example, the coordinate measuring machine 100 can be configured as a component of a robot, for example as a robot arm, on the end effector (not shown) of which the measuring head 36 is arranged. The term “coordinate measuring machine” is accordingly to be interpreted broadly as any type of system that is suitable for capturing coordinates of a measurement object.

When sensing the surface of the measurement object 14, the probe head 40 generates an electrical measurement signal, on the basis of which it is possible to ascertain the dimensional properties of the measurement object 14 to be measured. In other example embodiments, the geometry of the measurement object 14 to be measured can be ascertained optically by way of one or more cameras which, for example, are arranged on the free end of the quill 26. In order to approach the measurement points on the measurement object 14, the measuring head 36 is displaced relative to the workpiece receptacle 12 or to the measurement object 14 by means of the drives 20, 24, 28. To this end, the drives 20, 24, 28 receive control commands from an evaluation and control unit 42, 44, on the basis of which the drives 20, 24, 28 are driven in each case on their own or together (for example, by way of CNC driving).

In FIG. 1, the evaluation and control unit 42, 44 is connected to the coordinate measuring machine 100 by way of cables. A wireless connection is likewise conceivable. Moreover, it is possible for the evaluation and control unit 42, 44 to be integrated in the coordinate measuring machine 100 (e.g., in the base 10).

Here, the evaluation and control unit 42, 44 is represented in two parts and can contain a numerical machine controller 42 (computerized numerical controller) and a commercially available computer 44, which is provided with a commercially available operating system, such as Windows, OS X or Linux. The control commands for driving the drives 20, 24, 28 are preferably generated by a software application, which is executed on the computer 44. In principle, the computer 44 can also be integrated in the machine controller 42, or vice versa.

The CALYPSO software, marketed by the applicant, is an example software application. CALYPSO is software for planning measurement paths and for evaluating measurement points. A user creates a test plan by means of which the measurement object 14 should be measured, for example on the basis of CAD data of the measurement object. By means of the orientation to test features, CALYPSO makes it easier for the user to create/enter the measuring procedure because the test features generally correspond to specifications which the user can gather from a technical CAD drawing of the measurement object 14. With the selection of the test features, CALYPSO then creates the control commands which preferably express a measurement path with an associated start position and end position. The control commands are preferably transferred to the machine controller 42 by way of one or more cables or in wireless fashion.

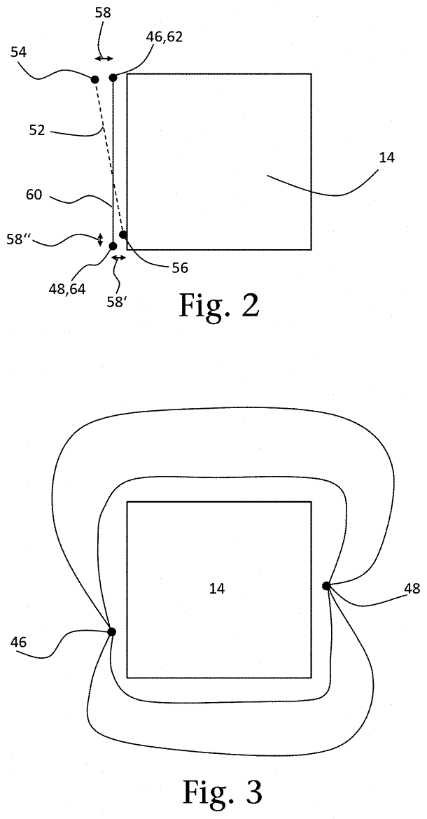

The evaluation and control unit 42, 44 is configured to receive an input command, which represents a first start position 46, from which the measuring head 36 should be displaced, and a first end position 48, at which the measurement point on the measurement object 14 is captured (see FIG. 2). The input command can be generated with the aid of the test plan or can arise automatically from the test plan. The evaluation and control unit 42 then accesses a data memory 50, which is represented here within the machine controller 42 for reasons of simplicity. Alternatively, it could be contained in the computer 44 or could be implemented as external data memory, for instance as network storage. The data memory 50 can contain a volatile RAM memory and/or a non-volatile memory, for instance an SSD memory. A database with a plurality of predefined measurement paths is stored in the data memory 50.

The evaluation and control unit 42, 44 is further configured to search for a first predefined measurement path 52 (see FIG. 2) with a second start position 54 and a second end position 56 in the database. In the process, a check is carried out whether the first and the second start position 46, 54 and the first and the second end position 48, 56 correspond within a predefined tolerance 58 or whether a comparison information item corresponds with a predetermined information item from a test plan. As indicated in FIG. 2, the tolerance 58 has an X-component and a Y-component 58′, 58″ in the two-dimensional case (and accordingly a Z-component in the three-dimensional case as well) and, for example, describes a deviation between the second start position 54 and the first start position 46 and/or a deviation between the second end position 56 and the first end position 48, which can be measured, for example, in millimeters (mm) or degrees (°).

If the first and the second start position 46, 54 and the first and the second end position 48, 56 correspond within the predefined tolerance 58 and/or if the comparison information item corresponds with the predetermined information item, the evaluation and control unit 42, 44 reads the first measurement path 52 from the database and drives the drives 20, 24, 28 in order to move the measuring head 36 along the first measurement path 52 from the second start position 54 to the second end position 56.

By contrast, if the first and the second start position 46, 56 and/or the first and the second end position 48, 56 do not correspond within the predefined tolerance 58 and/or if the comparison information item does not correspond with the predetermined information item, a second measurement path 60 with a third start position 62 and a third end position 64 is calculated by the evaluation and control unit 42, 44 on the basis of the first start position 46 and the first end position 48. Advantageously, the second measurement path 60 is stored in the database. In this case, the machine controller 42 drives the drives 20, 24, 28 in such a way that the measuring head 36 is moved along the second measurement path 60 from the third start position 62 to the third end position 64.

The measurement point on the measurement object 14 is recorded in the form of the measurement signal after the second or third end position 56, 64 has been reached (depending on the case). Then, measurement software on the computer 44 determines the dimensional properties of the measurement object 14 on the basis of the measurement signal. It is understood that determining the dimensional properties can contain a plurality of measurement signals from a plurality of measurement points.

It should be mentioned that the recalculated third start position and third end position 62, 64 correspond in example fashion to the first start position and first end position 46, 48 in FIG. 2; however this corresponds to the rule, with certain exceptions. Since the calculation is implemented, as a rule, by means of a random number-based algorithm, however, this may be different in other example embodiments. This is because the random number-based calculation can lead to different measurement paths with different lengths or travels being calculated for one and the same start position and end position 46, 48. This is illustrated schematically in FIG. 3, wherein four measurement paths of different length are shown in example fashion for the entered first start position and first end position 46, 48. The movement of the measuring head 36 around the measurement object 14 (or around the safety square 14 in the case of FIG. 3) is in the clockwise direction for two measurement paths and in the anticlockwise direction for two measurement paths.

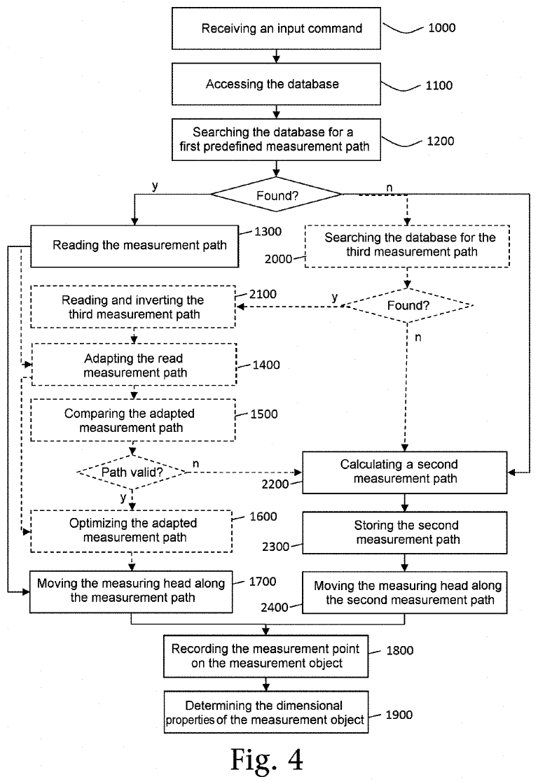

FIG. 4 shows a flowchart which illustrates an example embodiment of the novel method which can be performed on the novel apparatus 100. The input command representing the first start position 46 and the first end position 48 is received in a first step 1000. The database in which the plurality of predefined measurement paths are stored, each of the latter having a predefined start position and end position, is accessed in step 1100. The plurality of measurement paths emerge, for example, from preceding coordinate measurements. The database is searched for a first predefined measurement path 52 with the second start position 54 and the second end position 56 in step 1200. The search 1200 is implemented on the basis of whether the first and the second start position 46, 54 and the first and the second end position 48, 56 correspond within the predefined tolerance 58 and/or whether the comparison information item corresponds with the predetermined information item from the test plan, for example.

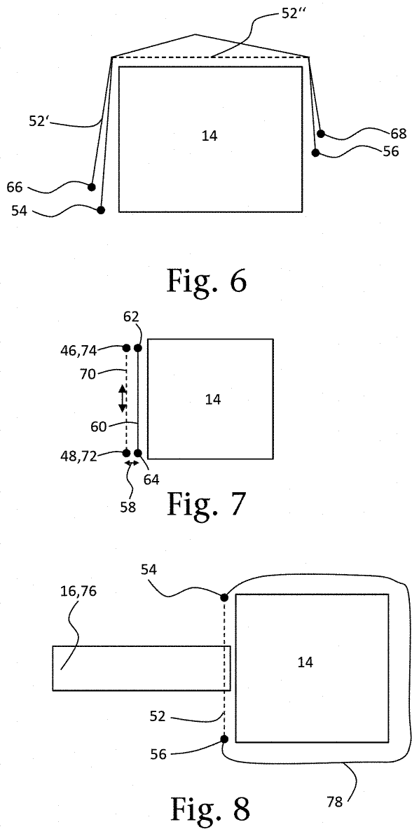

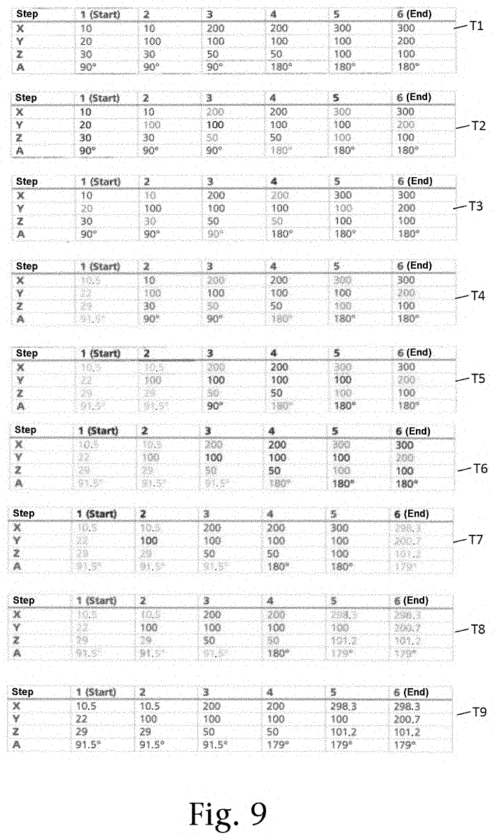

If the first and the second start position 46, 54 and the first and the second end position 48, 56 correspond within the predefined tolerance 58 and/or if the comparison information item corresponds with the predetermined information item from the test plan (“y” after step 1200), the first measurement path 52 has been found and the first measurement path 52 is read from the database in step 1300. In an optional step 1400, the second start position 54 and/or the second end position 56 can preferably be adapted for compensating the predefined tolerance 58, from which an adapted second start position and/or second end position 66, 68 emerge (see FIG. 6). As a rule, a plurality of intermediate positions between the respective start position and end position are also adapted, as illustrated in FIG. 9 in example fashion. Here, the second start position 54 corresponds to an original start position whereas the adapted second start position corresponds to an actual start position. An equivalent statement applies to the second and the adapted second end position 56, 68. Following the optional step 1400, the respectively adapted start position 66 can be compared to the first start position 46 and the respectively adapted end position 68 can be compared to the first end position 48 in a further optional step 1500. If the first and the adapted second start position 46, 66 and the first and the respectively adapted second end position 48, 68 correspond within the predefined second tolerance (“y” after step 1500), the adapted and/or compared measurement path 52′ can be optimized by an optimization algorithm in a further optional step 1600, wherein such an optimization yields, for example, a shortening of the adapted measurement path 52′, i.e., an optimized measurement path 52″ (see FIG. 6). Then, the measuring head 36 is moved along an adapted, compared and/or optimized measurement path 50, 52′ or 52″, depending on the optional embodiment, in step 1700. Subsequently, the measurement point on the measurement object 14 is recorded with the aid of the measuring head 36 in step 1800. The dimensional properties of the measurement object 14 are determined in step 1900 on the basis of the recorded measurement point. Preferably, it is not only one measurement point but a plurality of measurement points that are captured on the measurement object 14 and the overall geometry of the measurement object 14 is ascertained on the basis of the captured measurement points. Explicit reference is once again made to the fact that steps 1400, 1500, and 1600 are optional in each case and merely represent advantageous embodiments of the novel method. Consequently, none, or only one, of the steps 1400, 1500, and 1600 might be performed.

By contrast, if the first and the second start position 46, 54 and the first and the second end position 48, 56 do not correspond within the predefined tolerance 58 and/or if the comparison information item does not correspond with the predetermined information item from the test plan when searching through the database in step 1200 (“n” after step 1200), the first measurement path 52 has not been found in the database. In an advantageous yet optional step 2000, the database can however then be searched for a third predefined measurement path 70 with a fourth start position 72 and a fourth end position 74 in supplementary fashion, in which the first start position 46 and the fourth end position 74 and the first end position 48 and the fourth start position 72 correspond to one another within the predefined tolerance 58 (see FIG. 7). If the third predefined measurement path 70 is found in optional step 2000 (“y” after step 2000), the third measurement path 70 is read from the database and inverted in a subsequent, optional step 2100.

The fourth start position and fourth end position 72, 74 are interchanged such that a movement direction in which the measuring head 36 moves is likewise reversed. This is indicated schematically in FIG. 7 by a double-headed arrow. Following optional step 2100, at least one of steps 1400, 1500 or 1600 can optionally be carried out, or the method alternatively jumps directly to step 1700.

If no third measurement path 70 is found (“n” after step 2000), by contrast, the second measurement path 60 with a third start position 62 and a third end position 64 is calculated in step 2200 on the basis of the input command (see FIG. 7). In step 2300, the second measurement path 60 is stored in the database of the data memory 50. In step 2400, the measuring head is moved along the second measurement path 60 from the third start position 62 to the third end position 64. In this case (“n” after step 1200), steps 1800 and 1900 follow step 2400. It should be mentioned that step 1200 and optional step 2000 can be implemented at the same time or successively in time. Moreover, it should be mentioned that steps 2200, 2300, 2400, 1800, and 1900 are carried out in sequence after the aforementioned optional step 1500 in the case of a negative test result (“n” after step 1500). In the case where optional step 2000 is not implemented, the method jumps to step 2200 following an “n” after step 1200.

If no corresponding third measurement path was found after step 2000, it is advantageous to search for alternative measurement paths (fallback options) if the database access fails, i.e., no appropriate measurement path was found, and to adapt the alternative measurement paths to the boundary conditions which are determined by the first start position and first end position. Here it is conceivable for the search for such fallback options to be recursive and multi-stage, i.e., be accompanied by a plurality of iteration or search steps.

Additionally, a check can still be carried out after step 2100 as to whether the measuring path in step 1400 should be adapted, for example if a predetermined boundary condition is satisfied. Should this boundary condition not be satisfied, a second measurement path can then alternatively also be recalculated in step 2200 in place of the adaptation, and so the method would jump from step 2100 to step 2200 in this case (not illustrated).

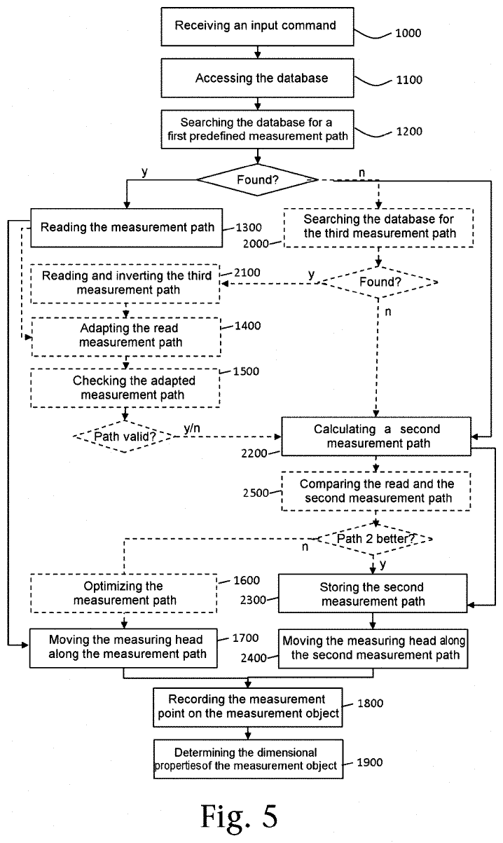

FIG. 5 illustrates a flowchart of a second example embodiment of the novel method. Only differences to the first example embodiment shown in FIG. 4 are discussed in this case. According to the second example embodiment, the calculation of the second measurement path 60 as per step 2200 follows the check of the adapted measurement path in optional step 1500, independently of the outcome of this optional test. Optionally, there can be a comparison of the first measurement path 52 or the adapted measurement path 52′ with the calculated second measurement path 60 in an optional step 2500 that follows step 2200. Should the second measurement path 60 be better (“y” after step 2500), steps 2300, 2400, 1800, and 1900 are carried out in sequence. By contrast, if the second measurement path 60 is not better (“n” after step 2500), the optimization step 1600 can optionally be carried out or the method proceeds directly with steps 1700, 1800, and 1900. In the case where one or more optional steps can be skipped, this path is labeled by a solid arrow in the flowcharts, whereas optional step sequences are connected by dashed arrows.

FIG. 8 shows a first measurement path 52, retrieved from the memory, between the second start position and second end position 54, 56; however, it is interrupted by a collision object 76. If the measuring head 36 were now to be displaced along this measurement path 52, this would result in a collision and possibly a destruction of the measuring head 36. By way of example, the collision object 76 can be one of the aforementioned fastening elements 16. To avoid the collision, a new, collision-free measurement path 78 is preferably calculated by the novel method.

To adapt the measurement path from the data memory 50 to the actual start position and end position, it is advantageous to analyze the measurement path and, where possible, adapt all degrees of freedom of the coordinate measuring machine 100 (like in step 1400). This is illustrated in example fashion in FIG. 9. Table T1 shows an example measurement path, wherein the values of the degrees of freedom in each position traveled on a measurement path from a start position to an end position is depicted over time. Now, according to one example embodiment of the novel method, an analysis is carried out as to what degree of freedom changes at what point. By way of example, this corresponds to the optimization step 1600 and is illustrated in table T2, wherein the change in the degrees of freedom is determined starting from the start position. The changes are illustrated starting from the end position in table T3. Subsequently, the positions are altered starting from the start position in such a way that the values of the start position are used for as long as no change of the respective degree of freedom is specified. This is illustrated in tables T4-T6. The same is carried out starting from the end position; this is illustrated in tables T7 and T8. The procedure consequently describes an iterative process. Overall, an optimized measurement path is obtained (for example, after step 1600), by means of which unnecessary movements of the movement axes are avoided (see table T9).

A precondition for this method is that the “character” of the stored measurement path, which, as it were, represents the “template” for the modification, fits to the currently desired measurement path. By way of example, if the measurement path from the buffer contains no information items about a rotary movement (i.e., for example, a change between the degrees of freedom 4 to 6 in the respective header of the tables of FIG. 9), but the current start position and end position require such a rotary movement (for example, because the degree of freedom 4 changes between the start configuration and end configuration), the adaptation illustrated in FIG. 9 is insufficient; instead, it must be supplemented, for example manually, with a rotary movement. However, in such a case it is more advantageous as a matter of principle for a second measurement path to be recalculated.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc). The phrase at least one of A, B, and C should be construed to mean a logical (A OR B OR C), using a non-exclusive logical OR, and should not be construed to mean “at least one of A, at least one of B, and at least one of C

1. A method for determining dimensional properties of a measurement object using a coordinate measuring machine, the coordinate measuring machine including a measuring head movable with respect to the measurement object, the method comprising:
receiving an input command including an information item representing a desired measurement path from a desired start position to a desired end position;
searching a data memory to find a first predefined measurement path corresponding to the information item, wherein the data memory stores a plurality of predefined measurement paths each including a respective predefined start position and a respective predefined end position, and wherein the first predefined measurement path includes a first start position and a first end position;
in response to the search being successful such that the first predefined measurement path corresponds to the information item:
reading the first predefined measurement path from the data memory, and
moving the measuring head along the first predefined measurement path from the first start position to the first end position and capturing at least one measurement point on the measurement object;
in response to the search being unsuccessful such that no predefined measurement path corresponding to the information item is found:
calculating a second measurement path with a second start position and a second end position based on the input command,
storing the second measurement path in the data memory, and
moving the measuring head along the second measurement path from the second start position to the second end position and capturing the at least one measurement point; and
determining the dimensional properties of the measurement object based on the captured at least one measurement point.

2. The method of claim 1 wherein:
the information item includes at least one predefined tolerance, and
the search is determined to be successful in response to both of:
the desired start position and the first start position corresponding within the at least one predefined tolerance, and
the desired end position and the first end position corresponding within the at least one predefined tolerance.

3. The method of claim 2 further comprising:
in response to the search being unsuccessful, searching the data memory for a third predefined measurement path having a fourth start position and a fourth end position, such that the desired start position and the fourth end position correspond within the at least one predefined tolerance and the desired end position and the fourth start position correspond to one another within the at least one predefined tolerance; and
in response to the third predefined measurement path being found:
reading the third predefined measurement path from the data memory,
inverting the third predefined measurement path to obtain an inverted third measurement path starting from the fourth end position and leading to the fourth start position, and
moving the measuring head along the inverted third measurement path from the fourth end position to the fourth start position and capturing the at least one measurement point.

4. The method of claim 2 further comprising adapting at least one of the first start position and the first end position to compensate for the at least one predefined tolerance.

5. The method of claim 1 further comprising, in response to the search being successful:
calculating the second measurement path based on the input command;
comparing the first predefined measurement path and the second measurement path;
storing the second measurement path in the data memory;
in response to the second start position having a smaller deviation from the desired start position than the first start position has from the desired start position, moving the measuring head along the second measurement path; and
in response to the second end position having a smaller deviation from the desired end position than the first end position has from the desired end position, moving the measuring head along the second measurement path.

6. The method of claim 1 further comprising, in response to the search being successful:
optimizing the first predefined measurement path to determine a first optimized measurement path; and
moving the measuring head along the first optimized measurement path from the first start position to the first end position.

7. The method of claim 1 wherein:
the data memory has a predefined storage capacity; and
the predefined storage capacity is determined by a predefined number of storable, predefined measurement paths.

8. The method of claim 7 further comprising, in response to the predefined number of storable, predefined measurement paths having been reached:
identifying at least one stored, predefined measurement path that has not been selected within a predefined number of searches of the data memory; and
deleting the at least one stored, predefined measurement path.

9. The method of claim 7 further comprising, in response to the predefined number of storable, predefined measurement paths having been reached:
determining a shortest measurement path of the stored, predefined measurement paths; and
deleting the shortest measurement path.

10. The method of claim 1 wherein at least some of the plurality of predefined measurement paths include at least one of:
a displacement speed of the measuring head for one or more path sections between the respective start and end positions;
a travel between the respective start and end positions;
a tolerance value for the respective start positions;
a tolerance value for the respective end positions;
a collision object arranged between the respective start and end positions;
a rotary angle along a kinematic chain of the coordinate measuring machine; and
a movement preference for a movement sequence of movement axes of the coordinate measuring machine.

11. The method of claim 1 further comprising:
determining a respective key value based on the respective predefined start position and end position and the plurality of predefined measurement paths,
wherein each measurement path in the data memory is identified by the respective key value.

12. The method of claim 11 wherein the respective key value is further determined based on a predefined tolerance.

13. The method of claim 11 wherein:
the data memory is formed as a hash table in which the plurality of predefined measurement paths are stored,
a respective index value is assigned to each of the predefined measurement paths,
the method comprises, for each of the plurality of predefined measurement paths, calculating an associated hash value based on the respective key value using a hash function,
the respective hash value defines the respective index value, and
the respective measurement path is accessed via the respective hash value in the hash table.

14. The method of claim 1 wherein the data memory is implemented as a database.

15. The method of claim 14 further comprising maintaining the database.

16. An apparatus for determining dimensional properties of a measurement object, the apparatus comprising:
a workpiece receptacle configured to hold the measurement object;
a measuring head configured to capture at least one measurement point on the measurement object, wherein the measuring head is displaceable relative to the workpiece receptacle;
a plurality of drives configured to displace the measuring head along a plurality of movement axes;
an evaluation and control unit configured to control the plurality of drives and to receive a measurement signal that the measuring head generates when capturing the at least one measurement point; and
a data memory including a database configured to store a plurality of predefined measurement paths each including a respective predefined start position and a respective predefined end position,
wherein the evaluation and control unit is configured to:
receive an input command including an information item representing a desired measurement path from a desired start position to a desired end position;
search the database to find a first predefined measurement path corresponding to the information item, wherein the first predefined measurement path includes a first start position and a first end position;
in response to the search being successful such that the first predefined measurement path corresponds to the information item:
read the first predefined measurement path from the database, and
move the measuring head along the first predefined measurement path from the first start position to the first end position and capture the at least one measurement point;
in response to the search being unsuccessful such that no predefined measurement path corresponding to the information item is found:
calculate a second measurement path with a second start position and a second end position based on the input command,
store the second measurement path in the database, and
move the measuring head along the second measurement path from the second start position to the second end position and capture the at least one measurement point; and
determine the dimensional properties of the measurement object based on the captured at least one measurement point.

17. A non-transitory computer-readable medium comprising instructions including:
receiving an input command including an information item representing a desired measurement path from a desired start position to a desired end position;
searching a data memory to find a first predefined measurement path corresponding to the information item, wherein the data memory stores a plurality of predefined measurement paths each including a respective predefined start position and a respective predefined end position, and wherein the first predefined measurement path includes a first start position and a first end position;
in response to the search being successful such that the first predefined measurement path corresponds to the information item:
reading the first predefined measurement path from the data memory, and
moving a measuring head of a coordinate measuring machine along the first predefined measurement path from the first start position to the first end position and capturing at least one measurement point on a measurement object;
in response to the search being unsuccessful such that no predefined measurement path corresponding to the information item is found:
calculating a second measurement path with a second start position and a second end position based on the input command,
storing the second measurement path in the data memory, and
moving the measuring head along the second measurement path from the second start position to the second end position and capturing the at least one measurement point; and
determining dimensional properties of the measurement object based on the captured at least one measurement point.

18. The computer-readable medium of claim 17 further comprising the data memory.

19. The computer-readable medium of claim 18 wherein the data memory is structured as a database.
